(19) United States
(12) Patent Application Publication
(10) Pub. No.: US 2015/0175424 A1
(43) Pub. Date: Jun. 25, 2015

(54) PROCESS FOR THE PRODUCTION OF PHOSPHORIC ACID

(71) Applicant: Italo Innamorati, Martellago (Venezia) (IT)

(72) Inventor: Italo Innamorati, Martellago (Venezia) (IT)

(21) Appl. No.: 14/138,269

(22) Filed: Dec. 23, 2013

(51) Int. Cl. C01B 25/231

(52) U.S. Cl. CPC C01B 25/231

(57) ABSTRACT

The present invention concerns a process for producing phosphoric acid including at least one step of mixing sulphuric acid with a mass in reaction so as to obtain a homogeneous mixture, in which the mixing is carried out faster than the germination times of calcium sulphate hemihydrate crystals and also of calcium sulphate dihydrate in order to prevent the spontaneous germination of the hemihydrate and dihydrate calcium sulphates and in which there is a step of controlled production of calcium sulphate dihydrate germs.

### TECHNICAL FIELD OF THE INVENTION

The present invention concerns a new process for the production of phosphoric acid.

### STATE OF THE ART

As it is known, in order to produce phosphoric acid, with formula H₃PO₄, the so-called “Dorr-Oliver” process is generally used, according to which, in general, sulphuric acid, with formula H₂SO₄, is mixed with calcium phosphate, for example with phosphorite, i.e., a sedimentary rock rich in calcium phosphate, thereby producing the crystallization of the calcium sulphate dihydrate, with formula CaSO₄.2H₂O, so-called gypsum, in a bath of H₃PO₄ and water. Thereafter, the thus obtained phosphoric acid is separated from the gypsum.

However, there are two factors that greatly limit the performance of such a process.

First of all, the reaction temperature of the sulphuric acid with the phosphorite must be kept below about 82° C., since at higher temperatures calcium sulphate hemihydrate, with formula (CaSO₄)₂.H₂O, is formed (which is used in the building field and is known by the name “plaster of Paris”). Such a salt, when washed with water over a filter, sets and transforms into calcium sulphate dihydrate, thereby blocking the process.

Thus, taking into account the fact that the reaction speed of sulphuric acid with phosphorite increases as the reaction temperature increases (speed which can be evaluated based on the Arrhenius law), it can be understood how the maximum reaction speed that can be obtained in the conventional process (for example Dorr-Oliver) used up to now is, due to the above, greatly limited.

Regarding this, indeed, at the boiling temperature (about 105° C.) of the homogeneous mixture or etching reaction mass (known as pulp and formed from a mixture of water, sulphuric acid, phosphoric acid, phosphorite and gypsum) the reaction speed is five times greater than that at 82° C.

In order to partially balance the low reaction speed, usually the phosphorite is finely ground before the reaction with sulphuric acid for obtaining a faster breaking up of the phosphorite; this results in high costs for the required grinding device, the containers for the ground phosphorite, the moving apparatuses as well as for workers, for maintenance and the electrical energy; by operating with speeds 5 times higher it is possible to use non-ground or only slightly ground phosphorite.

It should also be considered that in the conventional process (for example Dorr-Oliver) proposed up to now, the gypsum crystallization takes place without the possibility of controlling and, as will be understood, it would be very advantageous to be able to control, as desired, the size of the gypsum crystals forming, since large sized crystals are easier to be separated from the phosphoric acid produced and, moreover, a smaller outer surface of the gypsum results in less entrainment, by the gypsum itself, of the phosphoric acid and, finally, larger gypsum crystals provide a mass that is more permeable to water or to the washing fluid of the gypsum.

### OBJECTS OF THE INVENTION

Therefore, the main object of the present invention is to provide a new process for producing phosphoric acid.

Another object of the present invention is to provide a process for producing phosphoric acid, which ensures that a high reaction speed is obtained.

Another object of the present invention is to provide a process for producing phosphoric acid, in which it is possible to control the crystallization of the gypsum and therefore the size of the gypsum crystals formed.

In accordance with an aspect of the invention a process according to claims 1, 2 and the dependent claims is provided.

### BRIEF DESCRIPTION OF THE DRAWING

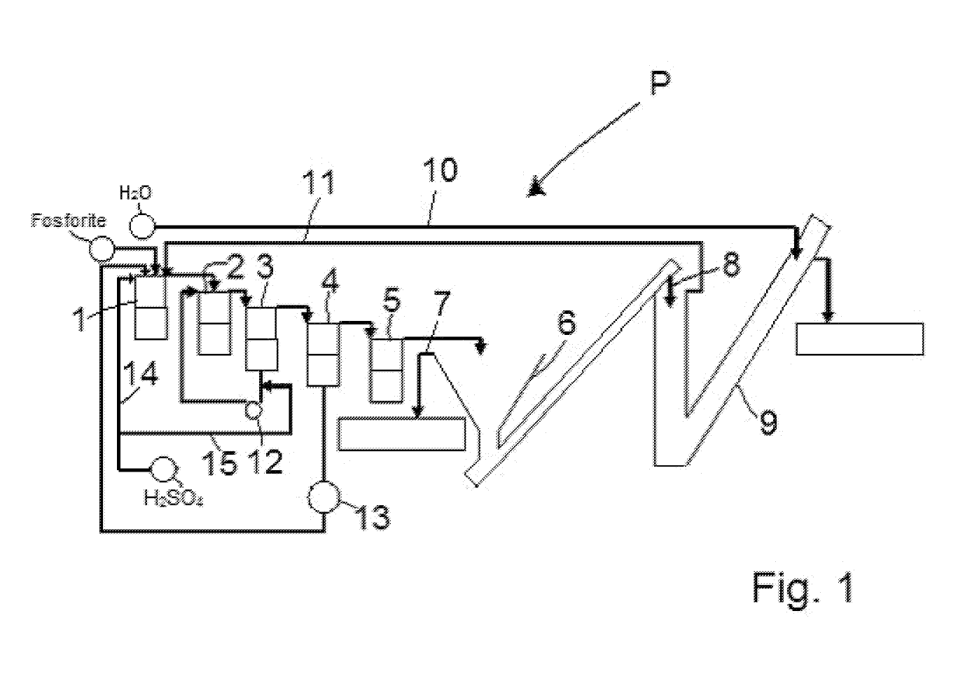

Other features and advantages of the invention will become clearer from the description of an embodiment of the process, illustrated for indicating purposes in the attached drawing in FIG. 1 that indeed illustrates a schematic view of a plant for carrying out the process according to the present invention.

### EMBODIMENTS OF THE INVENTION

Bearing in mind the above considerations, the Applicant of the present patent application has devised a process for producing phosphoric acid, owing to which it is possible to prevent the formation of calcium sulphate hemihydrate and, instead, to stabilize the formation of gypsum or calcium sulphate dihydrate crystals at temperatures at which calcium sulphate hemihydrate is stable.

As it is known, indeed, calcium sulphate hemihydrate crystals form following the formation of nuclei or germs of the salt itself, and arrangement in the crystalline matrix of the hemihydrate of Ca⁺⁺ and SO₄⁻ ions and molecules of H₂O, ions obtained following insertion in reaction of sulphuric acid and phosphorite. In the present application by germs it is to be meant tiny crystals formed in certain conditions directly from ions.

For obtaining the formation of calcium sulphate hemihydrate germs, it is necessary to have a concentration of the Ca⁺⁺ and SO₄⁻⁻ ions that is greater both than the saturation concentration and than a critical specific concentration value for obtaining spontaneous germination. Moreover, it is possible, even with concentration values of ions lower than the critical value, to obtain germination by stimulating it through artificial means, for example by hitting the slightly oversaturated saline solution with a sound wave (the Applicant of the present patent application produced a saturated saline solution in a beaker and with the addition of further salt and with simple stirring made it oversaturated: by striking the glass of the beaker with a glass rod, the solution turned from clear to opaque and, left to rest, tiny crystals, i.e. germs, were deposited on the bottom of the beaker). Of course, it is more practical and cost effective to employ “natural” germination, controlling it suitably.

The concentration of Ca⁺⁺ ions in the reaction volume is almost constant and, therefore, the aforementioned critical concentration values is exceeded in the point of insertion of the sulphuric acid, i.e. where the concentration of SO₄⁻⁻ ions is at its maximum.

Moreover, it should be noted that the grouping together of the Ca⁺⁺ and SO₄⁻ ions and of H₂O in the crystalline matrix until a germ is formed takes place in a very short, but finite time.

According to the present invention, it has been found that if the sulphuric acid is mixed with the mass of component in reaction, with the mass in reaction including a mixture of phosphorite, calcium sulphate crystals, sulphuric acid, phosphoric acid and water, in a time shorter than that required for the germination of calcium sulphate hemihydrate crystals (in practical experiments the mixing was carried out in 0.06 seconds) and the sulphuric acid is mixed with an amount of mass of components in reaction such as to bring the concentration of sulphuric acid in the mixture to a value lower than the minimum concentration suitable for producing germination of the calcium sulphate hemihydrate, the minimum concentration that we identify as critical for the germination of the calcium sulphate hemihydrate (in practical experiments the flow rate of the mass to be added to the sulphuric acid was such as to have a concentration of sulphuric acid in the mixture equal to 20 grams per litre) the germination is inhibited, thereby preventing the formation of calcium sulphate hemihydrate crystals.

### First Experiment

A first experiment was carried out, during which in an industrial plant having a capacity of 90 tonnes per day of phosphoric acid, indicated as P2O5, the sulphuric acid entering into the process was mixed with a mass in reaction or pulp (made up as stated above) taken from an attack or reaction reactor, thereby obtaining a homogeneous mixture.

The taking was carried out by means of a pump equipped with a Kaplan type impeller in which, in addition to the pulp, the process sulphuric acid was also injected. The impeller of the pump also acted as mixing apparatus (flow rate of the pump: 3000 m³/h; mixing time: 0.06 seconds; sulphuric acid concentration in the mixture obtained: 20 g/l).

The reaction temperature was brought to 95° C. (by decreasing the removal of heat developed by the attach reaction of the phosphorite) and it was checked that in the exposed conditions calcium sulphate hemihydrate has not formed (actually no signs of the gypsum taking on the filter used for the separation of the phosphoric acid from the gypsum were detected, signs that were detected in the same plant with a conventional process when the temperature of the attack reactors exceeded 82° C.)

Actually, by working in temperature conditions (95° C.) where calcium sulphate hemihydrate is stable, but preventing the formation of germs thereof, the Ca⁺⁺ and SO₄⁻⁻ ions, deriving from the attack or reaction of phosphorite with sulphuric acid, bond with the calcium sulphate dihydrate crystals according to the matrix of this salt and the resulting crystals, although in conditions of metastability, are unaltered.

### Second Experiment

In the plant used in the first experiment the temperature of 82° C. was reset in the attach reactors, keeping actuated the sulphuric acid mixing device described in the first experiment.

It was found that the separation of gypsum and the washing thereof on the filter became progressively quicker (actually the point of disappearance of the supernatant liquid on the gypsum in the trays of the filter shifted progressively towards the feeding point of the tray), which means that, since the flow rates of the liquids is constant, the permeability of the panel of gypsum and therefore the size of the crystals increased.

The plant worked in these conditions with continuous improvement of the performance of the filter, in other words rapidity of separation of the acid from the gypsum and of the subsequent washing thereof.

At a certain time the pulp fed to the filter modified: the solid phase, which consisted of large gypsum crystals became a mush of tiny crystals, i.e., gypsum germs.

The test was repeated and it was found that the crisis point, in other words the time when the pulp transformed as above stated, was always after the same operating time, which, in this specific case was 15 hours, but obviously the time period is correlated to the production capacity and to the volume of the reactors.

The phenomenon was construed in the following way. The conditions that inhibited the generation of calcium sulphate hemihydrate germs, described above, inhibited too the formation of gypsum or calcium sulphate dihydrate germs.

During the second experiment, therefore, in the attack reactors there were no new calcium sulphate dihydrate germs and therefore new crystals did not form. The crystals present were also progressively removed by the supply of the filter, and, consequently the crystalline surface available for the deposit of the Ca⁺⁺ and SO₄⁻⁻ ions decreased in the reactors.

In such conditions, therefore, the concentration of said ions progressively increased in the attack or reaction bath until, once the critical germination concentration was reached, the Ca⁺⁺ and SO₄⁻⁻ ions, in an oversaturation state, aggregated in the form of tiny crystals, i.e., germs.

### Third Experiment

The plant in the conditions of the second experiment could not operate or work, since there was not a sufficient amount of germs, germs which, of course, as stated above, had to be calcium sulphate dihydrate germs.

The mixing conditions of the sulphuric acid were left unchanged, as in the previous experiments, but an amount of sulphuric acid (equal to 10% by volume of the process flow rate) was inserted in the attack pulp (in which Ca⁺⁺ ions are present) at a temperature lower than 82° C., i.e., conditions for producing and inserting into the process calcium sulphate dihydrate germs were generated.

The operation of the plant proved to be stable with good quality gypsum (more easily filtered than that produced in a conventional plant).

It was attempted to decrease (from 10% to 9%, then 8%, then to 7% and finally to 6% by volume) the amount of sulphuric acid sent to the production of germs and it was found that as the amount of acid inserted in this step decreased, the performance of the filter increased; in other words, as the amount of sulphuric acid inserted into the reactor that produced germs decreased, the amount of germs produced and inserted into the reaction volume decreased; since the attack or reaction produced a constant amount of Ca⁺⁺ and SO₄⁻⁻ ions such ions, distributed over a lower number of germs, created larger crystals, i.e., which are easier to filter.

### Fourth Experiment

In the arrangement described for the third test, i.e., preventing the “wild” or uncontrolled production of gypsum germs and replacing it with an adjustable production thereof, the cooling of the attack reactors was reduced, taking the temperature thereof to 95° C., i.e., to a temperature where calcium sulphate hemihydrate is stable.

No sign of setting of the gypsum was detected at the filter. This means an absence of calcium sulphate hemihydrate. Therefore, the formation of calcium sulphate dihydrate crystals remained stable.

Such a salt, metastable at 95° C., did not undergo any transformation into hemihydrate for the entire residency time (about 2 hours) in the reactors, therefore arriving at the filter as such, where, washed with water at room temperature, it is brought to a temperature of about 50° C., i.e., into an area where calcium sulphate dihydrate is stable.

In order to best highlight the effect of the test on the size of the crystals let us take a numerical example.

If a plant with a conventional cycle produces a mass per hour of gypsum equal to M g per hour and we count the relative number of crystals we will find a number that we indicate as N.

This means that the plant has produced and made available to the process N germs.

The average mass m of the crystals will therefore be

m=M/N g

If we inhibit spontaneous germination and replace it with adjustable germination and adjust it for a production of a number of nuclei N′=N/100, we will produce crystals of average mass m′

m′=M/N′=M/N/100=100*m g.

This means that the crystals produced will be 100 times larger.

The fourth experiment was carried out for obtaining a higher production of phosphoric acid, using the existing conventional plant.

Therefore, the plant was adapted as a function of the desired capacity.

Hereafter we thus describe a conventional plant adapted, according to the present invention, for the precise purpose of obtaining greater capacity.

In the reaction or attack reactors a temperature equal to 95° C. (stability limit of the rubber coating of the reactors of said plant) was maintained.

The feeding of phosphorite and sulphuric acid was progressively increased (with respect to the previous feeding for capacities of 90 tonnes per day of P2O5) up to a capacity of 150 tonnes per day of P2O5 [increase in capacity of (150−90)/90*100=66%].

The capacity of the phosphorite grinding plant was adapted to the new situation by grinding coarser (if d is the average diameter of the ground phosphorite for the conventional cycle, the set up of the mills was modified to obtain an average diameter equal to 1.3*d). The capacity of the mills therefore increased according to the relationship of the squares of the average diameters (1.3*d)²/d²=1.69).

The flow rate of the sulphuric acid sent to the production of germs was adjusted to 8% by volume of the process flow rate to have gypsum of appropriate size to carry out the extraction of the acid and the washing of the gypsum in the filter without loss of efficiency.

In order to dispose of the greatest amount of gypsum from the filter the following procedure was carried out.

In the filter, of the tray type, the flow speed was increased by about 30%.

It was also allowed an increase of the thickness of the gypsum panel in the tray until the new flow rate of gypsum could be disposed of.

The flow rate of water for washing the gypsum was increased disproportionally to the increase in capacity of the plant (66%), but only by about 25% of that fed with conventional operation.

In this way phosphoric acid was produced with a concentration in P2O5 of 31% instead of the concentration of 26% that was obtained with the conventional set up (low concentration due to the fact that the sulphuric acid used was at a concentration of 70% because sub-produced by a plant for concentration of nitric acid).

Owing to this it was possible to concentrate 150 t/h of P2O5 in the subsequent concentration plant, instead of 90.

The reaction speed at 95° C., equal, based on Arrhenius law, to 2.4 times that at a temperature of 82° C., was used as follows (the reaction speed at 82° C. is considered the speed measurement unit).

| | |
|---|---|
| Speed available: | 2.4 |
| Speed for the capacity of 90 t/h | −1 |
| Speed for the increase in capacity and consequent decrease in | −0.66 |
| the residency time in the reactors with fixed volume | |
| Speed to face the average diameter of the phosphorite 1.3*d | −0.15 |
| instead of d (1.3 − 1)/2 = | |
| Speed up capability 2.4 − 1 − 0.66 − 0.15 = | 0.59 |

The reaction speed up capability of 0.59, since the objective of 150 t/day of capacity had been reached, was left to enhance the efficiency of extraction of the P2O5.

The plant in the conditions described was left in regular operation. The following table shows the results obtained compared to those of previous operation with the conventional cycle.

TABLE 1

| | Present | Conventional for | |
|---|---|---|---|
| Process | invention | reference | Difference |
| Capacity t/day in P2O5 | 150 | 90 | 60 |
| Capital expenditure | 1 | 1 | 0 |
| Efficiency % | 95 | 93.5 | 1.5 |
| Workforce costs | 1 | 1 | 0 |
| Maintenance costs | 1 | 1 | 0 |
| Electrical energy | 1 | 1 | 0 |
| Steam | 1.2 | 1 | 0.2 |
| Operating materials | 1 | 1 | 0 |
| Increased gypsum capacity | 1.66 | 1 | 0.66 |

Plant Layout According to the Invention

With reference to FIG. 1 the layout of a possible plant P according to the present invention has been illustrated, which comprises at least one pre-mixing reactor 1 and, according to the example illustrated in the Figures, four reaction reactors 2, 3, 4 and 5.

The reactor 1 is a pre-mixer or pre-mixing reactor of phosphorite that also acts as producer of gypsum germs and into which sulphuric acid (only the amount required for the controlled production of germs, an amount that can vary between 5% and 10% by volume, preferably between 8% and 6% by volume) and calcium phosphate (possibly phosphorite) are fed. In order to have liquid phase to suspend the phosphorite the diluted phosphoric acid 11 coming from the washing of the gypsum is fed into the reactor 1. For the same reason, but also to introduce Ca++ ions for the production of gypsum germs suspended attack pulp taken from the attack reactor 4 is introduced into the reactor 1.

The temperature of the reactor 1 is kept below 82° C. to ensure the absence of calcium sulphate hemihydrate germs, a temperature that can easily be ensured since raw materials enter into the reactor 1 at room temperature.

The reactors 2, 3, 4 and 5 are the attack reactors or reaction reactors of phosphorite and for the crystallization of gypsum. The reaction mass leaving the pre-mixing reactor 1 is fed into the reaction reactors.

The mixture exiting from the pre-mixer 1 is fed in sequence into the reactors 2, 3, 4 and 5, where the disaggregation of the phosphorite and the growth of the gypsum crystals is carried out.

More specifically:
the reactor 2 is fed with the mixture in outlet from the reactor 1 as well as pulp taken from the bottom of the reactor 3 mixed with 90-95% by volume (preferably 92-94% by volume) of process sulphuric acid with sulphuric acid/pulp ratio such as to have a sulphuric acid concentration in the mixture that is lower than the critical germination concentration; and
the reactors 3, 4, 5 are fed with the mixture in outlet from the previous reactor, thus 2, 3 and 4 respectively.

The final mixture leaving the reactor 5, consisting of phosphoric acid, water, gypsum and traces of sulphuric acid is treated in a decanter 6, from which, on the surface, the phosphoric acid produced 7 comes out, whereas the gypsum is extracted from the bottom with the Archimedean screw 8. The gypsum, in outlet by the Archimedean screw 8, is then washed in the Archimedean screw 9, where a washing takes place in perfect countercurrent with water. The liquid deriving from the washing is a diluted solution of phosphoric acid 11 that is recycled into the reactor 1 to introduce therein, as stated earlier, liquid phase designed to suspend the phosphorite.

The process sulphuric acid is divided into two parts: 5-10% by volume 14, as stated, goes into the pre-mixer 1, whereas the remaining 95-90% by volume 15 goes directly (in other words without passing in the pre-mixing reactor 1) into the reaction reactor 2. Beforehand, however, said sulphuric acid (between 95 and 90% by volume of the process amount), through a pump 12, is injected into the pulp taken from the reactor 3 in an amount such as to obtain a mixture with sulphuric acid concentration lower than the critical concentration for spontaneous germination. Therefore, it is such a mixture of pulp and sulphuric acid that is then injected into the reactor 2.

It should be noted that the cooling apparatus of the attack reactors, present in the plant with conventional cycle, is eliminated, if the plant is run at the boiling temperature in the attack or reaction reactors.

As it will be understood, by using an inclined Archimedean screw instead of the filter (a solution made possible owing to the large size of the gypsum) advantages are obtained in terms of investment cost, efficiency of extraction of the soluble P2O5 carried by the gypsum, workforce costs, cost of operating materials (for example the mesh of the filters) and energy.

An estimation of the performance of a phosphor plant that can be made as described and with the process according to the present invention compared with that of a conventional plant having an equal capacity is shown in the following table.

TABLE 2

| | Present | Conventional |
|---|---|---|
| Process | invention | process |
| Capacity | X | X |
| Investment | 0.6 | 1 |
| Efficiency | 96 | 93.5 |
| Fixed costs | | |
| Workforce | 0.6 | 1 |
| Maintenance | 0.6 | 1 |
| Variable costs | | |
| Electrical energy | 0.6 | 1 |
| Steam | 0.5 | 1 |
| Operating materials | 0.4 | 1 |
| Increased gypsum capacity | 1 | 1 |

The base criteria of the process according to the present patent application can be easily adapted to plants with machinery based on the conventional process, as can be seen from the above described experiment four.

It should be noted that the described arrangement is not the only one possible.

Referring to the machinery available and the objectives of the installation the elasticity of the system allows various adaptations (reduction of fixed or variable costs).

According to the present invention, a process for producing phosphoric acid through attack of the phosphorite with sulphuric acid at a temperature of over 82° C. is thus provided without there being formation of calcium sulphate hemihydrate crystals.

Moreover, advantageously, a process according to the present invention also comprises steps for controlling the size of the calcium sulphate dihydrate crystals that form in an environment of over-saturation of the ions that deposit on such crystals. These steps are aimed in particular at preventing the natural or spontaneous germination of gypsum crystals and replacing the natural spontaneous germination with a controlled germination in which the amount of nuclei produced is adjustable.

Modifications and variants of the invention are possible within the scope of protection defined by the claims.

1. Process for the production of phosphoric acid comprising at least one step of mixing sulphuric acid with a mass in reaction, thereby obtaining a homogeneous mixture, said mass in reaction including a mixture of phosphorite, calcium sulphate crystals, sulphuric acid, phosphoric acid and water, wherein said mixing is made faster than the germination times of calcium sulphate hemihydrate crystals and also of calcium sulphate dihydrate crystals in order to prevent the spontaneous germination of said hemihydrate and dihydrate calcium sulphates and comprising a step of controlled production of calcium sulphate dihydrate germs.

2. Process for the production of phosphoric acid according to claim 1, wherein during said mixing the ratio between sulphuric acid and said mass in reaction is such that the concentration of sulphuric acid in said homogeneous mixture is lower than the minimum concentrations suitable for producing spontaneous germination of said hemihydrate and dihydrate calcium sulphates.

3. Process according to claim 1, wherein an amount of calcium sulphate dihydrate germs is produced in a controlled manner through injection of an adjustable amount of sulphuric acid in said mass in reaction at a temperature lower than that of germination of calcium sulphate hemihydrate.

4. Process according to claim 1, wherein an amount of calcium sulphate dihydrate germs is produced in a controlled manner through artificial stimuli at a temperature lower than that of germination of the calcium sulphate hemihydrate.

5. Process according to claim 1, comprising a step of providing a plant comprising at least one pre-mixing reactor and at least one reaction reactor, and wherein phosphorite, liquid phase consisting of diluted phosphoric acid, a mass in reaction coming from said at least one reaction reactor and sulphuric acid is fed into said pre-mixing reactor, whereas the homogeneous mixture exiting from said pre-mixing reactor is fed into said at least one reaction reactor.

6. Process according to claim 5, wherein said plant comprises at least two reaction reactors, and wherein the homogeneous mixture exiting from a first reaction reactor is fed into a second reaction reactor.

7. Process according to claim 6, wherein an amount of homogeneous mixture taken from said second reaction reactor is fed to said first reaction reactor.

8. Process according to claim 5, wherein a flow rate of sulphuric acid is injected into said at least one first reaction reactor.

9. Process according to claim 6, wherein a flow rate of sulphuric acid is injected into said homogeneous mixture taken from said second reaction reactor and fed to said at least one first reaction reactor.

10. Process according to claim 5, wherein in said pre-mixing reactor a temperature is kept at which the calcium sulphate dihydrate is stable.

11. Process according to claim 5, wherein in said at least one pre-mixing reactor a temperature lower than about 82° C. is kept.

12. Process according to claim 5, wherein in said at least one reaction reactor a temperature higher than about 82° C. is kept.

13. Process according to claim 5, wherein an amount of between 5% and 10% by volume of sulphuric acid is injected into said pre-mixing reactor, whereas between 95% and 90% by volume of sulphuric acid is introduced into said at least one reaction reactor.

14. Process according to claim 5, wherein an amount of between 6% and 8% by volume of sulphuric acid is injected into said pre-mixing reactor, whereas between 94% and 92% by volume of sulphuric acid is introduced into said at least one reaction reactor.

15. Process according to claim 5, wherein the final mixture exiting from said at least one reaction reactor is fed into a decanter where phosphoric acid is separated from calcium sulphate dihydrate.

16. Process according to claim 15, wherein said calcium sulphate dihydrate gypsum is washed in an Archimedean screw in countercurrent with water.

17. Process according to claim 15, wherein said calcium sulphate dihydrate gypsum is washed in an Archimedean screw in countercurrent with water, wherein the liquid deriving from said washing step comprises a diluted phosphoric acid solution that is recycled in said first pre-mixing reactor.
